(19) United States
(12) Patent Application Publication
(10) Pub. No.: US 2002/0158879 A1
(43) Pub. Date: Oct. 31, 2002

(54) Graphic output unit and a graphic output system

(76) Inventors: Bernd Broghammer, Tennenbronn (DE); Karl Buehler, Bad Duerrheim (DE); Guenther Huber, Bad Duerrheim (DE); Michael Maier, Villingen-Schwenningen (DE); Gerd Mauthe, Hausen o.V. (DE); Thomas Sagcob, Donaueschingen (DE); Juergen Vogel, Brigachtal (DE)

Correspondence Address: Patrick J. O'Shea, Esq., Samuels, Gauthier & Stevens, LLP, Suite 3300, 225 Franklin Street, Boston, MA, 02110, US

(21) Appl. No.: 09/748,702

(22) Filed: Dec. 21, 2000

(30) Foreign Application Priority Data
Dec. 21, 1999 (DE) 199 61 726.0

(51) Int. Cl. G06F 13/12; G06T 9/00

(52) U.S. Cl. 345/555

(57) ABSTRACT

A graphic output unit receives and processes an input signal to provide an image on a display in response to the input signal. The graphic output unit includes a bit stream decoder, a graphic controller, a graphic chip and an interface controller. The interface controller receives the input signal and provides a received signal indicative thereof, and determines the type of data within the input signal. If said input signal includes compressed data the interface controller routes the received signal to the bit stream decoder which decompresses the compressed data within said received signal and provides uncompressed pixel graphic data to the graphic chip. If the input signal includes pixel graphic data the interface controlled routes the received signal to the graphic chip. If the input signal includes vector graphic instructions the interface controller routes the received signal to the graphic controller which converts the vector graphic instructions to corresponding pixel graphic data and provides the corresponding pixel graphic data to the graphic chip. The graphic chip receives the pixel graphic data and provides a display output signal indicative thereof.

### BACKGROUND OF THE INVENTION

The present invention relates to a graphic output system that includes a graphic output unit 5 comprising a graphic chip, which processes pixel graphic data for reproduction on a display.

A graphic output unit is typically contained in a portable computer (e.g., laptop). Some laptops include a DVD drive that typically comprises an MPEG2 decoder that decompresses a bit stream of the compressed audio and video data from the DVD drive and provides the decompressed data to the graphic chip. The graphic chip processes the data by adapting it to the format and the set parameters of the display, and subsequently provides the data to the display of the laptop for display.

Laptops are generally stand-alone solutions, whose structure is very rigid and very cost-intensive.

Computers are also known, which have a graphic chip and a separate screen as an attachable display, corresponding to the laptop described above. The graphic chip is connected to a graphic controller that provides vector graphic instructions (e.g., “draw an arrow to the position A of the display”) that are converted to pixel graphic data and processed by the graphic chip for display on the screen. Such computers have proven to be very limited in processing the multiplicity of graphic data types.

Therefore, there is a need for a graphic output unit and a graphic output system that processes various types of graphic data.

### SUMMARY OF THE INVENTION

According to an aspect of the invention, a graphic output unit receives data various data types. The data are input to an interface controller that forwards to the data to the appropriate components of the graphic output unit based on the type of data it is. The data may be graphic data (e.g., vector graphic instructions), pixel graphic data, compressed graphic data, control data and/or audio data. Depending on the type of graphic data, the interface controller forwards the graphic data 5 to the appropriate components of the graphic output unit. For example, if the graphic data input to the interface controller are pixel graphic data., they are forwarded directly to a graphic chip; vector graphic instructions on the other hand are forwarded to a graphic controller. The graphic controller converts the vector graphic instructions into corresponding pixel graphic data and provides the data to the graphic chip; compressed graphic data are conducted to an appropriate bit stream decoder that decompresses the compressed graphic data into uncompressed pixel graphic data and provides the decompressed data to the graphic chip.

The graphic chip receives, individually or simultaneously pixel graphic data from the interface controller, the graphic controller, and the bit stream controller. The data are processed either individually or jointly, and output to the display for selective or joint reproduction. The graphic chip performs various graphic functions, including: fade-over, scrolling, windowing, rotation, zoom, etc. In particular, different pixel graphic data of different origin and different graphic data type can be linked and outputted jointly. For example, a video sequence input to the graphic output unit as compressed graphic data may be linked to the pixel graphic data of a vector graphic instruction, which for example puts a logo into the upper right-hand corner of the display, to form a joint representation on the display. Furthermore, the pixel graphic data input to the interface controller, and then to the graphic chip, may be conducted simultaneously to the graphic output unit and displayed directly either alone or jointly with other pixel graphic data of different origin or data type.

The input and the interface controller recognize the type of data received and forward the data accordingly, so various types of graphics data can be conducted to the graphic output unit and displayed. Advantageously, the graphic output unit of the present invention may be used with a variety of data types, without needing dedicated chips to handle certain data types. The components used in the graphic output unit are preferably standard parts (e.g., commercial-off-the-shelf components).

Parallel input of pixel graphic data to the graphic chip from the interface controller, from the bit stream decoder, and from the graphic controller, results in a flexible, economical structure. Providing various graphic data simultaneously to the graphic chip facilitates linking these data to one another in real-time and displaying the data jointly.

Besides one bit stream decoder, it has proven beneficial to install one or more additional bit stream decoders that are optimized to decode various compressed graphic data, and conduct the compressed data as pixel graphic data to the graphic chip. Each bit stream decoder preferably has a dedicated input path to the graphic chip so that the various graphic data can be linked.

The graphic chip may be connected to the graphic controller through a second connecting line so the graphic chip may be controlled by the graphic controller. Thus, control signals received by the graphic output unit (e.g., from a graphic data source remote from the graphic output unit or from a remote control panel) may modify the properties of the graphic output unit. The resolution of the display can also be controlled by control signals from the graphic data source, depending on the type of graphic data being transmitted. For example, if high-resolution graphic data are being transmitted (e.g., compressed graphic data in the JPEG or MPEG2 format) the resolution of the display may be chosen higher than for the simple display of texts or text elements on the basis of vector graphic instructions. When pixel graphic data of different origin or of different type are displayed in combination, the resolution is specified by the higher one.

The graphic controller preferably controls the graphic output unit, and in particular the timing of the various components of the graphic output unit and/or its turn-on and turn-off behavior, or its transition into a so-called sleep mode or its return from there. This design of the graphic controller as a control unit for individual components of the graphic output unit (especially for the graphic chip and/or for the entire graphic output unit) provides a simple and economical structure for a graphic output unit. In particular, it is independent of the type of data source or of the format of the graphic data.

The interface controller and the graphic controller are preferably designed to transmit both control data and vector graphic data over their connecting line. The control data may be transmitted both from the interface controller to the graphic controller and vice versa. This structure allows the graphic output unit to control the interface controller, the graphic controller, and through these the graphic chip and the graphic output unit. In particular, it is possible to control the graphic output unit and/or the graphic chip jointly through the interface controller and the graphic controller. The control tasks in this case preferably are distributed between the two controllers, to enable reliable and simple control of the graphic output unit through the “intelligence” that is present in each controller for converting graphic data or for distributing the data. This ensures control of the other components of the graphic output unit and thus of the graphic output unit itself.

According to a preferred development of the graphic output unit, the interface controller includes a MOST interface controller, and the input is designed to receive data corresponding to the MOST specification from a MOST bus. The MOST bus is a media-oriented-systems-transport-bus system, which connects decentralized components (i.e., data sources and/or data sinks). The MOST bus transmits both control data and source data (i.e., graphic, audio, or measurement data). The graphic data may be transmitted compressed and uncompressed, also coded or non-coded. The MOST bus is described in the article entitled “Video and Audio Applications in Vehicles Enabled by Network Systems”, available from IEEE, 1999, WPM 11.2, which is incorporated herein by reference.

The MOST interface controller ensures that the graphic output unit can be controlled by an arbitrary graphic data source with its specific graphic data format, so the graphic data may be displayed in a specific way. The combination of the inventive graphic output unit and a MOST communication system provides a flexible graphic system. The connecting lines between the individual units of the communication system are preferably designed as optical connecting lines, thus preventing electromagnetic interference on the signals that are being transmitted from a graphic data source to the graphic output unit.

The graphic output system may be used in a motor vehicle, since a motor vehicle offers only a very few places suitable for receiving units of such a communications system. For this reason, a decentralized arrangement of components is especially advantageous.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a block diagram illustration of a graphic output system; and

FIG. 2 is a block diagram illustration of a graphic output unit within the graphic output system of FIG. 1.

### DETAILED DESCRIPTION OF THE INVENTION

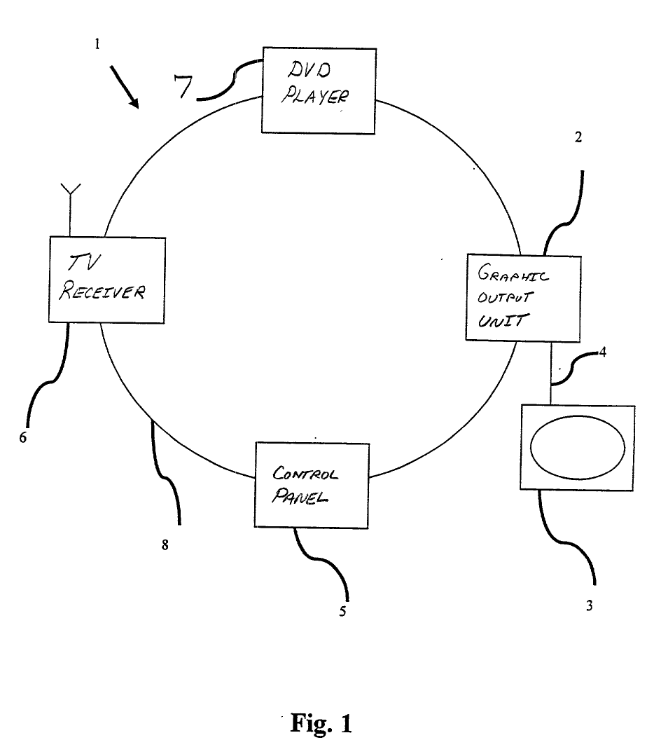

FIG. 1 is a block diagram illustration of a graphic output system 1 that includes several i4 graphic data sources, including a TV receiver 6 and a DVD player 7, and a control panel 5, a graphic output unit 2 and a display 3. These components are preferably connected together through a MOST bus system. The topology of the MOST bus is ring-shaped, with an optical connecting line 8. This connecting line 8 transmits both control data and source data (i.e., audio, video, and graphic data) via the MOST bus, among the individual components of the network. For example, in a motor vehicle the control panel 5 may be located in the vehicle at a location remote from the graphic output unit 2, the display 3, and the TV receiver 6. These components 2, 3, 6 may be controlled by the control panel 5. The graphic data of the graphic data sources are transmitted on the MOST bus connecting line 8 to the graphic output unit 2. The graphic data are processed by the graphic output unit and output on a line 4 to the display 3, which displays the graphic.

Graphic data from the TV receiver 6 are transmitted by the connecting line 8 of the MOST bus (e.g., as pixel graphic data) to the graphic output unit 2, which outputs the data to the display. The graphic data of the DVD player 6 are conducted to the graphic output unit 2 as compressed graphic data, especially as MPEG2-comptessed data. The graphic output unit 2 decompresses the compressed graphic data and then processes the data for presentation on the display 3.

The graphic output system 1 has several data sources 6 for graphic data. These, in turn, may have variously formatted graphic data that are conducted via the connecting line 8 of the MOST bus to the graphic output unit 2.

Besides its pure control input function, the control panel 5 may also transmit graphic instructions (e.g., vector graphic instructions) to the graphic output unit 2, which causes the corresponding input instructions to be displayed. Accordingly, various graphic data formats are made available to the graphic output unit 2. The inventive graphic output unit 2 processes the various graphic data formats from different graphic data sources, and displays the processed (e.g., decompressed) graphic image data.

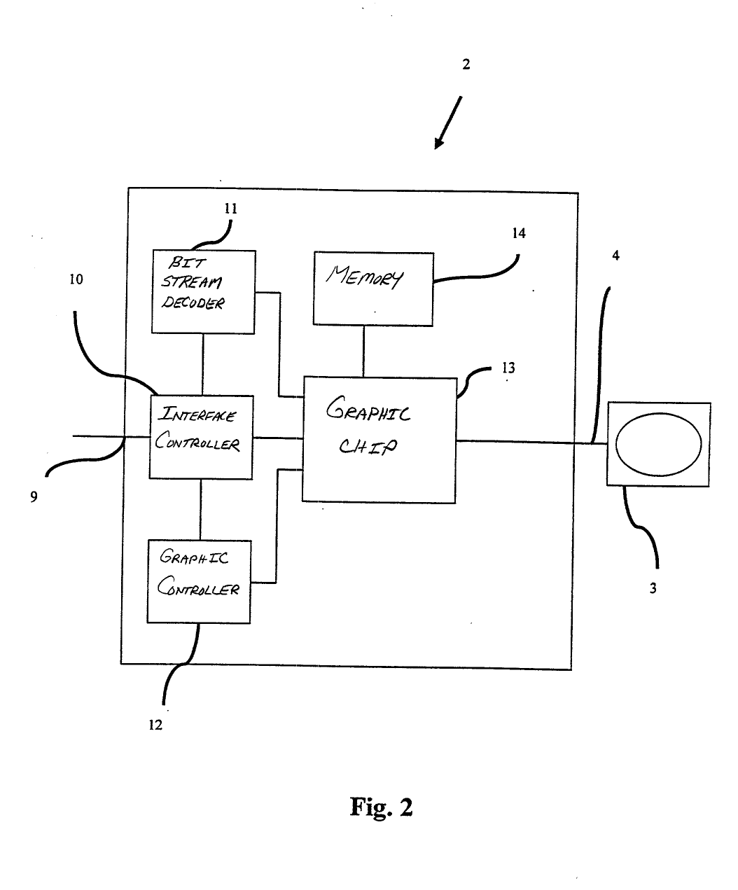

FIG. 2 is a functional block diagram illustration of the graphic output unit 2. The graphic data and the control data are input to the graphic output unit via an input port 9 that is coupled to the bus 8. The received data (control and graphic) are input to a MOST interface controller 10, depending on their data type.

The compressed MPEG2-coded graphic data are recovered from the inputted data stream and are conducted to a bit stream decoder 11, which includes an MPEG2 decoder. The bit stream decoder 11 decodes the compressed data and forms graphic data in the pixel graphic data format that are output to a graphic chip 13.

If the pixel graphic data are transmitted from the input 9 directly to the interface controller 10, the interface controller 10 transmits the data directly to the graphic chip 13.

On the other hand, vector graphic instructions are recovered from the inputted data stream by the interface controller 10, and output to the graphic controller 12. The graphic controller 12 converts the vector graphic instructions into pixel graphic data, and outputs the pixel graphic data to the graphic chip 12.

If the data stream coming through the input 9 contains control data for the graphic output unit 2, the control data are interpreted by the interface controller 10 and the graphic controller 12, and converted into control instructions for the graphic output unit 2 or the display unit 3; the graphic output unit 2 or the display unit 3 are controlled accordingly. The interface controller 10 and the graphic controller 12 thus share a control function in a mutually coordinated manner.

The graphic chip 13 receives pixel graphic data in parallel from the MPEG2-decoder 11, the 1 interface controller 10, and from the graphic controller 12. These pixel graphic data originally were differently coded graphic data. They are processed in the graphic chip 13, in which, for example, the various received pixel graphic data are mixed, linked, and displayed together, or these data are mutually converted or modified by fade-over or scrolling or windowing or rotation or zoom etc. The graphic chip 13 performs this type of processing uniformly, regardless of the origin of the pixel graphic data the memories 14 are associated with the graphic chip 13. These are used for fast and immediate retrieval of graphic data for processing in the graphic chip 13. This makes it possible to process the pixel graphic data in the graphic chip in a fast, reliable, and flexible manner.

The universal design of the graphic output unit 2 and the possibility of causing graphic data to be displayed regardless of their type, provides an economical, universal, and flexible system for displaying the graphic data generated in the graphic output system 1. The graphic data are displayed in a display unit 3, which receives output signals from the graphic chip 13.

Although the present invention has been shown and described with respect to several preferred embodiments thereof, various changes, omissions and additions to the form and detail thereof, may be made therein, without departing from the spirit and scope of the invention.

What is claimed is:

1. A graphic output unit that receives and processes an input signal to provide an image on a display in response to the input signal, said graphic output unit comprising:
a bit stream decoder;
a graphic controller;
a graphic chip; and
an interface controller that receives the input signal and provides a received signal indicative thereof and determines the type of data within the input signal, wherein (i) if said input signal includes compressed data said interface controller routes said received signal to said bit stream decoder which decompresses the compressed data within said received signal and provides uncompressed pixel graphic data to said graphic chip, (ii) if said input signal includes pixel graphic data said interface controlled routes said received signal to said graphic chip, (ii) if said input signal includes vector graphic instructions said interface controller routes said received signal to said graphic controller which converts the vector graphic instructions to corresponding pixel graphic data and provides said corresponding pixel graphic data to said graphic chip, wherein said graphic chip receives pixel graphic data and provides a display output signal indicative thereof.

2. The graphic output unit of claim 1, wherein said graphic chip is connected to said graphic controller via a second connecting line through which said graphic chip can be controlled by said graphic controller.

3. The graphic output unit of claim 1, wherein said graphic controller is apt to control the graphic output unit.

4. The graphic output unit of claim 2, wherein said interface controller and said graphic controller exchange and transmit both control data and vector graphic data over their connecting lines.

5. The graphic output unit of claim 3, wherein said interface controller and said graphic controller exchange control data and vector graphic data over their connecting lines to jointly control the graphic output unit.

6. The graphic output unit of claim 1, wherein said interface controller comprises a MOST interface controller.

7. A graphic output unit that receives and processes an input signal to provide an image on a display in response to the input signal, said graphic output unit comprising:
a bit stream decoder;
a graphic controller;
a graphic chip;
means, for receiving the input signal and provides a received signal indicative thereof, for determining the type of data within the input signal, wherein
(i) if said input signal includes compressed data, for providing said received signal to said bit stream decoder which decompresses the compressed data within said received signal and provides uncompressed pixel graphic data to said graphic chip;
(ii) if said input signal includes pixel graphic data, for providing said received signal to said graphic chip; and
(ii) if said input signal includes vector graphic instructions, for providing said received signal to said graphic controller which converts the vector graphic instructions to corresponding pixel graphic data and provides said corresponding pixel graphic data to said graphic chip,
wherein said graphic chip receives pixel graphic data and provides a display output signal indicative thereof.

8. The graphic output unit of claim 7, wherein means for determining the type of data within the input signal comprises a MOST interface controller.

9. The graphic output unit of claim 7, wherein said BIT stream decoder comprises an MPEG decoder.

10. The graphic output unit of claim 7, wherein said BIT stream decoder comprises an MPEG2 decoder.

11. A graphic output system, comprising:
A) a ring shaped optical data bus;
B) a plurality of graphic data sources, each connected to provide graphic data onto said optical data bus; and
C) a graphic output unit that receives and processes said graphic data to provide an image on a display in response to said graphic data, said graphic output unit comprising
(1) a bit stream decoder;
(2) a graphic controller;
(3) a graphic chip;
(4) means, for receiving said graphic data and providing a received signal indicative thereof, and for determining the type of data within said graphic data, wherein
(i) if said graphic data includes compressed data, for providing said received signal to said bit stream decoder which decompresses the compressed data within said received signal and provides uncompressed pixel graphic data to said graphic chip;
(ii) if said graphic data includes pixel graphic data, for providing said received signal to said graphic chip;
(ii) if said graphic data includes vector graphic instructions, for providing said received signal to said graphic controller which converts the vector graphic instructions to corresponding pixel graphic data and provides said corresponding pixel graphic data to said graphic chip,
wherein said graphic chip receives pixel graphic data and provides a display output signal indicative thereof.

12. The graphic output system of claim 11, wherein said ring shaped optical data bus comprises a MOST data bus, and said means for determining the type of data within the input signal comprises a MOST interface controller.
